(19) United States
(12) Patent Application Publication
(10) Pub. No.: US 2005/0063683 A1
(43) Pub. Date: Mar. 24, 2005

(54) Interactive CD-ROM postcard

(75) Inventors: Boran Kranjcevic, Split (HR); Marko Grgic, Vranjic (HR)

Correspondence Address: KATHLEEN T. PETRICH;STOKES LAWRENCE, P.S., 800 FIFTH AVENUE, SUITE 4000, SEATTLE, WA, 98104-3179, US

(73) Assignee: GIDEON d.o.o.

(21) Appl. No.: 10/985,225

(22) Filed: Nov. 10, 2004

(30) Foreign Application Priority Data
Mar. 21, 2003 (WO) PCT/HR03/00011
May 10, 2002 (HR) P20020407A

(51) Int. Cl. H04N 5/781

(52) U.S. Cl. 386/125; 386/126

(57) ABSTRACT

An Interactive CD ROM picture-postcard consisting of a picture-postcard (A) with four pages (1), (2), (3) and (4), a CD ROM (8) and an envelope (9) containing the picture-postcard and the CD ROM. The envelope (9) is made of a transparent or partially transparent material. At the first page (1), there is a space (B) for postage stamp and an address, and a space (C) for writing textual messages. The CD ROM is firmly fixed to the fourth page (4) in slots (6) and (7), opposite space (C) at the first page (1). The picture-postcard with the inserted CD ROM, folded along the edge (5), is inserted into envelope (9), which prevents unauthorized removal of the CD ROM for copying and its returning into the picture-postcard envelope without visible damage. The envelope (9) covers the entire page (4), whereas the page (1) is covered only partly, along a border or edge (11). The remaining free space, on any of the pages of the picture-postcard, is for commercial and other messages.

### RELATED APPLICATIONS

This application claims priority to PCT/HR03/00011, filed Mar. 21, 2003, which claims priority to Croatian Patent Application No. P20020407A, filed May 10, 2002.

### TECHNICAL FIELD

The present invention relates generally to interactive postcards. In particular, the present invention relates to an interactive postcard containing an electronic recording (CD ROM) of various information such as text, pictures, songs or music backgrounds, intended for replaying by electronic devices.

### BACKGROUND OF THE INVENTION

For many years, people have been trying to create an envelope by which they would send, besides a textual message from a voyage, more information on a place, town, region or country. This created the idea that a picture-postcard sent from a trip should, besides the textual message, also contain an electronic recording containing various information such as text, picture, song or musical background, intended for replaying by electronic media.

The musical picture-postcard idea is no novelty. As early as in the 1970s there appeared picture-postcards containing gramophone vinyl record with musical hits. Today, there are numerous musical picture-postcards of various technical solutions. The basic setbacks of most known solutions are that the CD ROM is not visible from outside, that it is placed in a pocket in which it freely moves, thus increasing the risk of damage in transport or mailing. With some solutions, the CD ROM can be easily taken out and be subjected to unauthorized copying and returned without damaging the outer envelope.

The patent document WO 00/56555 A, shows a picture-postcard made of cardboard with a recess to receive a maxi CD in the middle of the front side, all that, at both sides, packed in a transparent envelope. The transparent envelope keeps the CD pressed in the recess in transportation. At the back side of the picture-postcard, on the transparent envelope, there is affixed a label for text and address. The picture on CD makes a part of the same picture at the front side of the picture-postcard.

The patent document GB 2 333 753 A does not present a picture-postcard but a CD package for transportation, storage and displaying. By the first embodiment, the cardboard base has two leaves. At the front side of the right-hand leaf there is cut and raised a tongue that receives the CD. At the fold between the left and the right bases, there is a slot at the left base through which a small part of the CD appears when the left part of the cardboard base is folded over the right side. The left part of the cardboard base is narrower than the right part so that, after folding over, a part of the CD remains visible at the right base. At the second embodiment, with three leaves, only a part of the CD on the first leaf remains visible. At the third embodiment, with the four folds cardboard base, following folding in an accordion manner, the CD is not visible because the first and the third leaves are equally wide. At the fourth embodiment, also with four leaves, the two inner leaves are narrower and the outer one is cut oblique, to make a larger part of the CD remain visible at the first leaf, and also for better stability at displaying of the CD.

### SUMMARY OF THE INVENTION

The interactive CD ROM picture-postcard of this invention consists of a four-page picture-postcard (usually made of cardboard), an electronic CD ROM recording, and a transparent, or partly transparent, envelope in which the folded picture-postcard containing the CD ROM will be placed.

The invention relates to construction of an interactive CD ROM picture-postcard, consisting of four pages, where, at the first page, there will be the area for writing the address and a textual message, and at the fourth page, a directly visible electronic record, a CD ROM. The remaining free space at the second, the third and the fourth pages will be for various information, advertising, pictorial and textual messages. Such an interactive CD ROM picture-postcard is inserted in a transparent wrapping that will protect the CD ROM from unauthorized use and the picture-postcard from being damaged in transport. The total CD-ROM/picture-postcard mass is to be adjusted within the basic mail tariff.

The primary goal of the invention is to improve interactive CD ROM picture-postcards by protecting the CD ROM integrity. The secondary goal is to protect the improved CD ROM picture-postcard by fixing the CD ROM to protect it from damages by handling, transport, mailing and storing. A further goal of the invention is to provide an improved CD ROM picture-postcard with a transparent wrapping with an opening at the front side through which the addressee's address and textual message will be written down without taking the CD ROM picture-postcard out of the envelope.

These and other advantages will become more apparent upon review of the drawings, the Best Mode For Carrying Out the Invention, and the claims.

### BRIEF DESCRIPTION OF THE DRAWINGS

Like reference numerals are used to designate like parts throughout the several views of the drawings, wherein:

FIG. 1. is a front view of the first page of the interactive CD ROM picture-postcard invention in an envelope;

FIG. 2. is a rear view of the fourth page of the interactive CD ROM picture-postcard in the envelope;

FIG. 3. is a front view of the first and fourth pages of the interactive CD ROM picture-postcard shown unfolded without the envelope; and

FIG. 4. is a rear view of the second and third pages of the interactive CD ROM picture-postcard shown unfolded without the envelope.

### BEST MODE FOR CARRYING OUT THE INVENTION

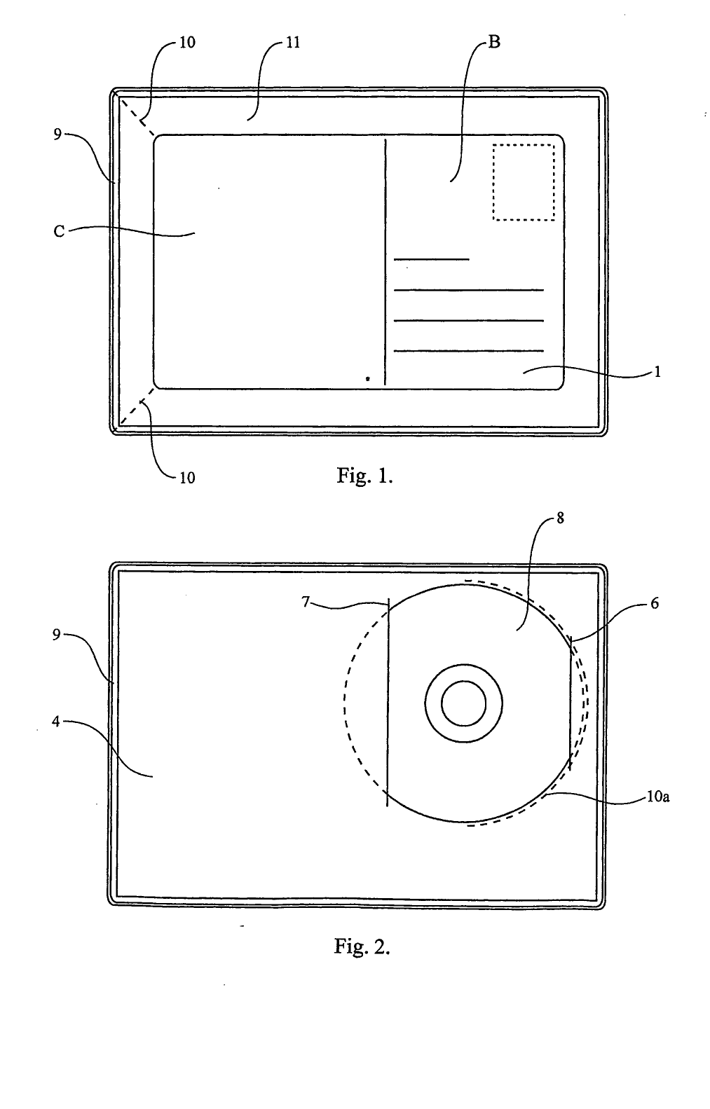

FIGS. 1, 2, 3, and 4 demonstrate the CD ROM picture-postcard of the present invention comprising a picture-postcard A (usually made of cardboard) with four pages: 1, 2, 3 and 4, a CD ROM 8 and an envelope 9 (usually made of plastics) in which the CD ROM is placed. The envelope 9 is made of a transparent or partly transparent material. Pages 1 and 2 of the picture-postcard A are connected with pages 3 and 4 and folded along the edge 5. The visual design of the interactive CD ROM picture-postcard, by this invention, does not make a subject matter of this protection, but remains free.

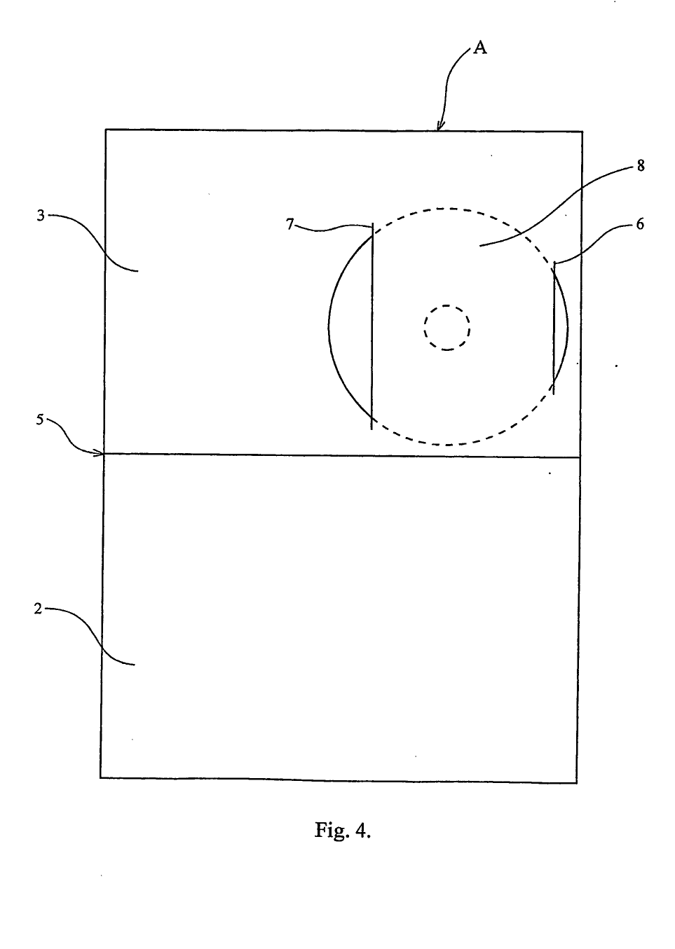

As shown in FIGS. 3 and 4, at page 1 of the picture-postcard A, there is the marked area B for postage stamp and the addressee's address, and the area C for writing textual messages down. Areas B and C may also contain various pictures or texts but in the background.

Spaces at pages 2 and 3 of the picture-postcard A may be used for pictorial and textual messages.

Through the pages 3 and 4 of the picture-postcard A, there is a short slot 6 parallel with or perpendicular to the page 1. And parallel with it, at a certain distance, is another slot 7 towards the middle of the pages 3 and 4 in which the CD ROM is inserted. In this way, a smaller part of the CD ROM remains at page 3 and a larger part of the CD ROM remains at page 4. As illustrated in FIG. 3, the CD ROM is located at page 4 opposite of the area C at page 1, thereby protecting the CD ROM from damage. This is because when the picture-postcard A is folded along the edge 5, the CD ROM is opposite of the place on the envelope where post date stamp is affixed.

The CD ROM is firmly fixed in slots 6 and 7, thus decreasing the risk of damage in transport and mail. The remaining free space at page 4 can be used for various information or commercial messages.

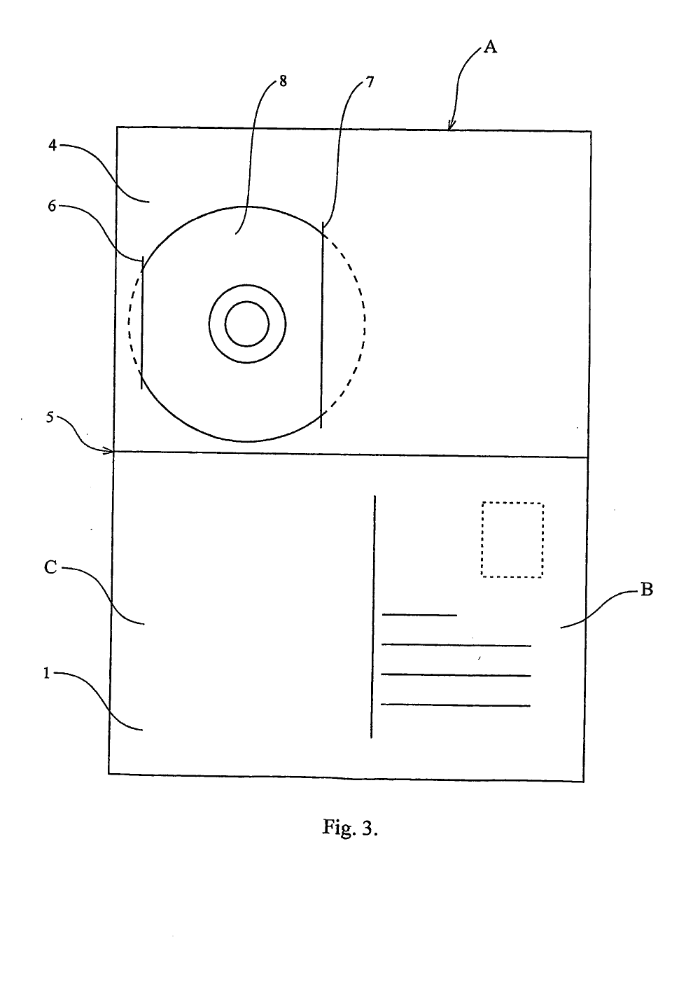

The picture-postcard A, with the CD ROM inserted in slots in the page 4 and folded along the edge 5, is inserted into the envelope 9. The entire page 4, at which the CD ROM is visible (FIG. 2) is covered by the envelope. Page 2 is covered by the envelope 9 only partially along the edge 11, as illustrated in FIG. 1. A major part of the page 1 remains uncovered and free so that the address and the message to the addressee can be written down in the areas B and C while the picture-postcard is in the envelope 9. The edge part 11 of the envelope 9, can be glued at page 1, with the glue not being the permanent kind but allowing removing of the envelope without damaging the picture-postcard.

There are two possibilities of easier removing the CD ROM 8 from the picture-postcard A and the envelope 9. The first is to make one or more perforations 10 in the edge part 11 of the envelope 9. The other is to make a semicircular perforation 10a (FIG. 2), corresponding to the outer shape of the CD ROM in the envelope 9 that covers the page 4.

The interactive CD ROM picture-postcard with envelope 9, embodied as described above, prevents unauthorized taking the CD ROM out, for its copying, and returning it into the envelope without causing visible damage.

The envelope 9 is made of a transparent or partly transparent material, so that the CD ROM and other pictorial and textual messages on pages 4 and 1 remain visible.

The invention application is obvious from its description. The interactive CD ROM picture-postcard is a modern way of sending pictorial and written messages from a voyage. CD ROM is a medium that can store a large volume of information, songs and musical backgrounds related to a place, area or country, that can be easily sent to another person.

The illustrated embodiments are only examples of the present invention and, therefore, are non-limitive. It is to be understood that many changes in the particular structure, materials, and features of the invention may be made without departing from the spirit and scope of the invention. Therefore, it is the intention of the patent applicant that its patent rights not be limited by the particular embodiments illustrated and described herein, but rather by the following claims interpreted according to accepted doctrines of claim interpretation, including the Doctrine of Equivalents and Reversal of Parts.

1. An Interactive CD ROM picture-postcard comprising:
a picture-postcard consisting of two folding, equal parts defining a first page and a fourth page on one side of the picture postcard capable of folding about an edge and a second page and a third page on the back side of the first and fourth pages also capable of folding about the edge, said first and second pages being positioned back-to-back and the said third and fourth pages being positioned back-to-back, wherein when the picture postcard is folded an outer edge is formed;
said third and fourth pages having a pair of slots, one short and the other longer than the short slot to receive a CD ROM and said first and fourth pages having a space for message text and a space for an address and postage;
the short slot is closer to the outer edge of the picture postcard and is parallel to the longer slot, which is parallel to the outer edge, and the longer slot is farther from the outer edge;
a CD ROM being received within the two slots; and
an at least partially transparent envelope encasing the picture postcard wherein the CD ROM is visible through a transparent portion of the envelope when the CD ROM is received within the slots of the picture-postcard.

2. The Interactive CD ROM picture-postcard according to claim 1 wherein the CD ROM is placed at the right-hand side of the fourth page and wherein a larger part of the CD ROM remains visible from looking at the fourth page.

3. The Interactive CD ROM picture-postcard according to claim 1 wherein the space for message text is on one side of the first page and the space for the address and postage is on the other side of the first page and wherein the CD ROM is positioned between the third and fourth pages, such that the when the picture-postcard is folded, the CD ROM is positioned on the back side of the space for message text.

4. The Interactive CD ROM picture-postcard according to claim 2 wherein the space for message text is on one side of the first page and the space for the address and postage is on the other side of the first page and wherein the CD ROM is positioned between the third and fourth pages, such that the when the picture-postcard is folded, the CD ROM is positioned on the back side of the space for message text.

5. The Interactive CD ROM picture-postcard according to claim 1 wherein the folded picture-postcard, with the CD ROM inserted within the slots of the picture-postcard, is inserted in the envelope that covers the entire fourth page so that the CD ROM remains visible, whereas the envelope covers the first page only partially along a border forming an opening so that a larger part of the first page remains uncovered and free in order that the address and a textual message can be written directly onto their corresponding spaces through the opening of the envelope; and wherein unauthorized access to the CD ROM for copying and returning it into the envelope without visible damage is prevented.

6. The Interactive CD ROM picture-postcard according to claim 2 wherein the folded picture-postcard, with the CD ROM inserted within the slots of the picture-postcard, is inserted in the envelope that covers the entire fourth page so that the CD ROM remains visible, whereas the envelope covers the first page only partially along a border forming an opening so that a larger part of the first page remains uncovered and free in order that the address and a textual message can be written directly onto their corresponding spaces through the opening of the envelope; and wherein unauthorized access to the CD ROM for copying and returning it into the envelope without visible damage is prevented.

7. The Interactive CD ROM picture-postcard according to claim 3 wherein the folded picture-postcard, with the CD ROM inserted within the slots of the picture-postcard, is inserted in the envelope that covers the entire fourth page so that the CD ROM remains visible, whereas the envelope covers the first page only partially along a border forming an opening so that a larger part of the first page remains uncovered and free in order that the address and a textual message can be written directly onto their corresponding spaces through the opening of the envelope; and wherein unauthorized access to the CD ROM for copying and returning it into the envelope without visible damage is prevented.

8. The Interactive CD ROM picture-postcard according to claim 5 wherein the border of the envelope over the first page has one or more perforations to easily remove the picture-postcard from the envelope.

9. The Interactive CD ROM picture-postcard according to claim 6 wherein the border of the envelope over the first page has one or more perforations to easily remove the picture-postcard from the envelope.

10. The Interactive CD ROM picture-postcard according to claim 7 wherein the border of the envelope over the first page has one or more perforations to easily remove the picture-postcard from the envelope.

11. The Interactive CD ROM picture-postcard according to claim 1 wherein the envelope includes a semicircular perforation over the fourth page to easily remove the CD ROM from the picture-postcard and the envelope.

12. The Interactive CD ROM picture-postcard according to claim 8 wherein the envelope includes a semicircular perforation over the fourth page to easily remove the CD ROM from the picture-postcard and the envelope.

13. The Interactive CD ROM picture-postcard according to claim 1 wherein the border of the envelope can be fixed to the first page by a non-permanent glue but enables removing of the envelope from the first page without damaging the picture-postcard.

14. The Interactive CD ROM picture-postcard according to claim 1 wherein the picture-postcard is made of cardboard.

15. The Interactive CD ROM picture-postcard according to claim 1 wherein the folded picture-postcard is rectangular in shape.

16. The Interactive CD ROM picture-postcard according to claim 2 wherein the folded picture-postcard is rectangular in shape.

17. An Interactive CD ROM picture-postcard comprising:
a picture-postcard consisting of two folding, equal parts defining a first page and a fourth page on one side of the picture postcard capable of folding about an edge and a second page and a third page on the back side of the first and fourth pages also capable of folding about the edge, said first and second pages being positioned back-to-back and the said third and fourth pages being positioned back-to-back, wherein when the picture postcard is folded an outer edge is formed;
said third and fourth pages having a pair of slots of a size to receive a CD ROM;
said first and fourth pages having a space for message text and a space for an address and postage;
a CD ROM being received within the two slots;
an at least partially transparent envelope encasing the picture postcard wherein the CD ROM is visible through a transparent portion of the envelope when the CD ROM is received within the slots of the picture-postcard;
wherein the folded picture-postcard, with the CD ROM inserted within the slots of the picture-postcard, is inserted in the envelope that covers the entire fourth page so that the CD ROM remains visible, whereas the envelope covers the first page only partially along a border forming an opening so that a larger part of the first page remains uncovered and free in order that the address and a textual message can be written directly onto their corresponding spaces through the opening of the envelope; and wherein unauthorized access to the CD ROM for copying and returning it into the envelope without visible damage is prevented.

18. The Interactive CD ROM picture-postcard according to claim 17 wherein the border of the envelope over the first page has one or more perforations to easily remove the picture-postcard from the envelope.

19. The Interactive CD ROM picture-postcard according to claim 17 wherein the folded picture-postcard is rectangular in shape.

20. The Interactive CD ROM picture-postcard according to claim 17 wherein the picture-postcard is made of cardboard.
